(19) United States
(12) Patent Application Publication
(10) Pub. No.: US 2021/0362687 A1
(43) Pub. Date: Nov. 25, 2021

(54) OPAQUE CLEANING FLUID FOR LIDAR SENSORS

(71) Applicant: Waymo LLC, Mountain View, CA (US)

(72) Inventor: Arthur Safira, Los Altos, CA (US)

(21) Appl. No.: 17/314,100

(22) Filed: May 7, 2021

Related U.S. Application Data
(60) Provisional application No. 63/028,255, filed on May 21, 2020.

(51) Int. Cl. B60S 1/48; G01S 7/481; G01S 17/931; G01S 17/89; G05D 1/00; G05D 1/02; B08B 3/04

(52) U.S. Cl. CPC B60S 1/48; G01S 7/4813; G01S 7/4816; B08B 3/04; G01S 17/89; G05D 1/0088; G05D 1/0231; G01S 17/931

(57) ABSTRACT

Aspects of the disclosure relate to systems for cleaning a LIDAR sensor. For example, the LIDAR sensor may include a housing and internal sensor components housed within the housing. The housing may also have a sensor input surface through which light may pass. The internal sensor components may be configured to generate light of a particular wavelength. In order to clean the LIDAR sensor, a cleaning fluid may be used. The cleaning fluid may be configured to be opaque to the particular wavelength. In this regard, when the cleaning fluid is applied to the sensor input surface, the cleaning fluid absorbs light of the particular wavelength.

### CROSS REFERENCE TO RELATED APPLICATIONS

This application claims the benefit of the filing date of U.S. Provisional Patent Application No. 63/028,255 filed May 21, 2020, the disclosure of which is hereby incorporated herein by reference.

### BACKGROUND

Various types of vehicles, such as cars, trucks, motorcycles, busses, boats, airplanes, helicopters, lawn mowers, recreational vehicles, amusement park vehicles, farm equipment, construction equipment, trams, golf carts, trains, trolleys, etc., may be equipped with various types of sensors in order to detect objects in the vehicle's environment. For example, vehicles, such as autonomous vehicles, may include such LIDAR, radar, sonar, camera, or other such imaging sensors that scan and record data from the vehicle's environment. Sensor data from one or more of these sensors may be used to detect objects and their respective characteristics (position, shape, heading, speed, etc.).

However, these vehicles are often subjected to environmental elements such as rain, snow, dirt, etc., which can cause a buildup of debris and contaminants on these sensors. Typically, the sensors include a housing to protect the internal sensor components of the sensors from the debris and contaminants, but over time, the housing itself may become dirty. As such, the functions of the sensor components may be impeded as signals transmitted and received by the internal sensor components are blocked by the debris and contaminants.

### BRIEF SUMMARY

One aspect of the disclosure provides a system for cleaning a LIDAR sensor. The system includes the LIDAR sensor. The LIDAR sensor has a housing and internal sensor components housed within the housing. The housing includes a sensor input surface through which light may pass and wherein the internal sensor components are configured to generate a light of a particular wavelength. The system also includes cleaning fluid that is opaque to the particular wavelength, such that when the cleaning fluid is applied to the sensor input surface, the cleaning fluid absorbs light of the particular wavelength.

In one example, the cleaning fluid is configured to reduce a likelihood of light of particular wavelength passing through the cleaning fluid resulting in a crosstalk artifact. In another example, the internal sensor components further include a plurality of receivers, and wherein reflected light the cleaning fluid reduces a likelihood of a reflected portion of the light being received at another of the plurality of receivers. In another example, the cleaning fluid is opaque in the visible spectrum of light. In this example, the cleaning fluid includes food coloring. In another example, the cleaning fluid is transparent in the visible spectrum of light. In another example, the cleaning fluid includes a pigment that is opaque to the particular wavelength. In another example, the system also includes a vehicle, and the LIDAR sensor is attached to the vehicle. In this example, the vehicle is configured to use sensor data generated by the LDAR sensor to make driving decisions for the vehicle when the vehicle is operating in an autonomous driving mode. In another example, the cleaning fluid is configured to mix with foreign object debris on the sensor input surface.

Another aspect of the disclosure provides method for cleaning a LIDAR sensor. The LIDAR sensor includes a housing and internal sensor components housed within the housing. The housing includes a sensor input surface through which light may pass, and the internal sensor components are configured to generate light of a particular wavelength. The method includes applying a cleaning fluid to the sensor input surface, wherein the cleaning fluid is configured to be opaque to the particular wavelength, and using the applied cleaning fluid to absorb light of the particular wavelength.

In one example, the method also includes using the applied cleaning fluid to reduce a likelihood of light of particular wavelength passing through the cleaning fluid resulting in a crosstalk artifact. In another example, the internal sensor components further include a plurality of receivers, and the method also includes using the applied cleaning fluid to reduce a likelihood of a reflected portion of the light being received at another of the plurality of receivers. In another example, the applied cleaning fluid is opaque in the visible spectrum of light. In this example, the applied cleaning fluid includes food coloring. In another example, applied cleaning fluid is transparent in the visible spectrum of light. In another example, the applied cleaning fluid includes a pigment that is opaque to the particular wavelength. In another example, the method also includes using data generated by the LIDAR sensor to make driving decisions for a vehicle when the vehicle is operating in an autonomous driving mode. In another example, the method also includes mixing the applied cleaning fluid with foreign object debris on the sensor input surface.

A further aspect of the disclosure provides a vehicle. The vehicle includes a LIDAR sensor. The LIDAR sensor includes a housing and internal sensor components housed within the housing. The housing includes a sensor input surface through which light may pass and wherein the internal sensor components are configured to generate a light of a particular wavelength. The vehicle also includes one or more processors configured to control the vehicle in an autonomous driving mode based on sensor data generated by the LIDAR sensor, and a cleaning fluid that is opaque to the particular wavelength, such that when the cleaning fluid is applied to the sensor input surface, the cleaning fluid absorbs light of the particular wavelength.

### BRIEF DESCRIPTION OF THE DRAWINGS

FIG. 1 is a functional diagram of an example vehicle in accordance with aspects of the disclosure.

FIG. 2 is an example external view of a vehicle in accordance with aspects of the disclosure.

FIG. 3 is an example functional representation of a sensor in accordance with aspects of the disclosure.

FIG. 4 is an example functional representation of a sensor and a cleaning system in accordance with aspects of the disclosure.

FIGS. 5A-5F are an example representation of aspects of a sensor when in operation in accordance with aspects of the disclosure.

FIGS. 6A-6G are an example representation of aspects of a sensor when in operation in accordance with aspects of the disclosure.

FIG. 7 is an example flow diagram in accordance with aspects of the disclosure.

FIGS. 8A-8F are an example representation of aspects of a sensor when in operation in accordance with aspects of the disclosure.

### DETAILED DESCRIPTION

### Overview

The technology relates to cleaning of light detection and ranging (LIDAR) sensors, for instance, for autonomous vehicles or other uses. LIDAR sensors may function by generating a pulse of light at a certain wavelength or range of wavelengths in a certain direction. The light may be reflected off of a surface of an object and returned back to the LIDAR sensor. The returning light passes through a sensor input surface or aperture of a housing of the sensor, such as glass, plastic, or other materials, and is directed via a series of lenses, mirrors, and/or waveguides back to one or more receivers. The returning light may be used to determine the location and reflectivity of the surface of the object. This data may be considered a LIDAR sensor data point. Point clouds or groups of LIDAR sensor data points can be generated using data from the LIDAR sensors.

LIDAR sensors may be utilized in a wide range of conditions, including conditions in which water and other foreign object debris will contact the outer aperture or sensor input surface of the LIDAR sensor. Water droplets and other foreign object debris can change the characteristics of the return light. For example, they may cause returning light to be directed towards the wrong internal receiver. This may result in “crosstalk artifacts” or artifacts that do not actually exist in the scene but appear due to light detected by internal receivers that are in proximity to one another, and can be amplified in LIDAR sensors that generate light in many different directions. Such artifacts are often found around objects that reflect a large amount of light back towards the LIDAR sensor, such as retroreflectors or specular reflectors at normal incidence, amplifying the impact of stray light paths to incorrect receivers of the LIDAR sensor.

In some instances, real objects can often be within these crosstalk artifacts seen in a point cloud. In addition, crosstalk artifacts can cause other signals to be lost as the LIDAR sensor may be saturated by the artifact signal before it receives light from actual objects in the scene further away.

Typical approaches for cleaning sensor apertures may involve utilizing cleaning fluids including water, alcohol, and other substances. However, these fluids themselves may amplify the problem when not fully cleared away, for instance, by air, wipers, or time.

To address these concerns, the cleaning fluid used to clean an aperture of a LIDAR sensor may be selected to be opaque for the wavelength or range of wavelengths of the light generated by the LIDAR sensor or rather, the operating wavelength or range of wavelengths. Different types of liquids and pigments may be added to typical cleaning fluids in order to make the cleaning fluid opaque for the wavelength or range of wavelengths of the light generated by the LIDAR sensor.

The cleaning fluid may be held in a reservoir. When needed, the fluid may be pumped from the reservoir through a line or other tubing until it reaches a nozzle. The nozzle may direct a spray of the cleaning fluid towards the aperture of the LIDAR sensor. Rotation or other movement of the sensor, a puff of air, and/or one or more wipers may then be used to clear the aperture of the cleaning fluid.

In this regard, any water droplets remaining as a result of the cleaning may also be opaque to the LIDAR sensor's operating wavelength or range of wavelengths. As such, any light that is opaque for the wavelength or range of wavelengths, hitting the cleaning fluid (or droplets mixed with the cleaning fluid) and that would have otherwise scattered in the wrong direction and be set to the wrong receivers, may be absorbed by the cleaning fluid. This may reduce the likelihood of crosstalk artifacts and thereby improve crosstalk performance of a LIDAR sensor. While there may be some impact on the range performance of the LIDAR sensor due to the any remnants of the cleaning fluid being left on the aperture after cleaning which may block some returning light from reaching the receivers, this may be balanced with the improvements with regard to crosstalk artifacts.

### Example Systems

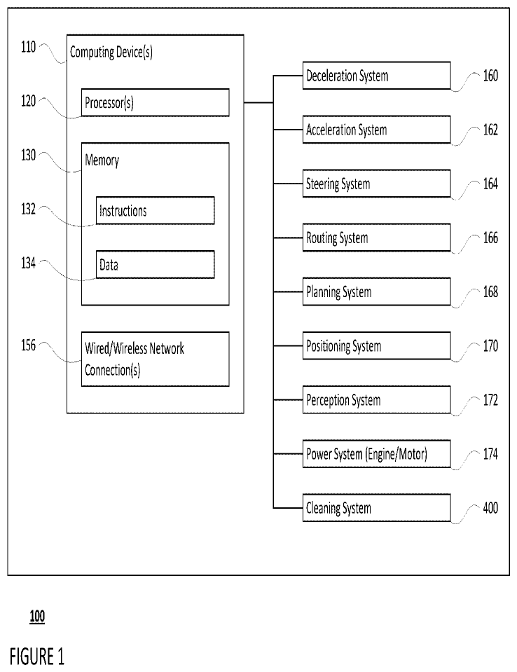

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, busses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 132 and data 134 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. As an example, data 134 of memory 130 may store predefined scenarios. A given scenario may identify a set of scenario requirements including a type of object, a range of locations of the object relative to the vehicle, as well as other factors such as whether the autonomous vehicle is able to maneuver around the object, whether the object is using a turn signal, the condition of a traffic light relevant to the current location of the object, whether the object is approaching a stop sign, etc. The requirements may include discrete values, such as “right turn signal is on” or “in a right turn only lane”, or ranges of values such as “having an heading that is oriented at an angle that is 20 to 60 degrees offset from a current path of vehicle 100.” In some examples, the predetermined scenarios may include similar information for multiple objects.

The one or more processor 120 may be any conventional processors, such as commercially available CPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. As an example, internal electronic display 152 may be controlled by a dedicated computing device having its own processor or central processing unit (CPU), memory, etc. which may interface with the computing device 110 via a high-bandwidth or other network connection. In some examples, this computing device may be a user interface computing device which can communicate with a user's client device. Similarly, the memory may be a hard drive or other storage media located in a housing different from that of computing device 110. Accordingly, references to a processor or computing device will be understood to include references to a collection of processors or computing devices or memories that may or may not operate in parallel.

Computing device 110 may all of the components normally used in connection with a computing device such as the processor and memory described above as well as a user input 150 (e.g., a mouse, keyboard, touch screen and/or microphone) and various electronic displays (e.g., a monitor having a screen or any other electrical device that is operable to display information). The vehicle may also include one or more wired and/or wireless network connections 156 to facilitate communications with devices remote from the vehicle and/or between various systems of the vehicle.

As an example, computing devices 110 may interact with deceleration system 160 and acceleration system 162 in order to control the speed of the vehicle. Similarly, steering system 164 may be used by computing devices 110 in order to control the direction of vehicle 100. For example, if vehicle 100 is configured for use on a road, such as a car or truck, the steering system may include components to control the angle of wheels to turn the vehicle.

Planning system 168 may be used by computing devices 110 in order to determine and follow a route generated by a routing system 166 to a location. For instance, the routing system 166 may use map information to determine a route from a current location of the vehicle to a drop off location. The planning system 168 may periodically generate trajectories, or short-term plans for controlling the vehicle for some period of time into the future, in order to follow the route (a current route of the vehicle) to the destination. In this regard, the planning system 168, routing system 166, and/or data 134 may store detailed map information, e.g., highly detailed maps identifying the shape and elevation of roadways, lane lines, intersections, crosswalks, speed limits, traffic signals, buildings, signs, real time traffic information, vegetation, or other such objects and information. In addition, the map information may identify area types such as constructions zones, school zones, residential areas, parking lots, etc.

The map information may include one or more roadgraphs or graph networks of information such as roads, lanes, intersections, and the connections between these features which may be represented by road segments. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features. While the map information may be an image-based map, the map information need not be entirely image based (for example, raster). For example, the map information may include one or more roadgraphs or graph networks of information such as roads, lanes, intersections, and the connections between these features which may be represented by road segments. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features.

Positioning system 170 may be used by computing devices 110 in order to determine the vehicle's relative or absolute position on a map and/or on the earth. The positioning system 170 may also include a GPS receiver to determine the device's latitude, longitude and/or altitude position relative to the Earth. Other location systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it which can often be determined with less noise than absolute geographical location.

The positioning system 170 may also include other devices in communication with the computing devices of the computing devices 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

The perception system 172 also includes one or more components for detecting objects external to the vehicle such as other vehicles, obstacles in the roadway, traffic signals, signs, trees, etc. For example, the perception system 172 may include lasers, sonar, radar, cameras and/or any other detection devices that record data which may be processed by the computing devices of the computing devices 110. In the case where the vehicle is a passenger vehicle such as a minivan, the minivan may include a laser or other sensors mounted on the roof or other convenient location.

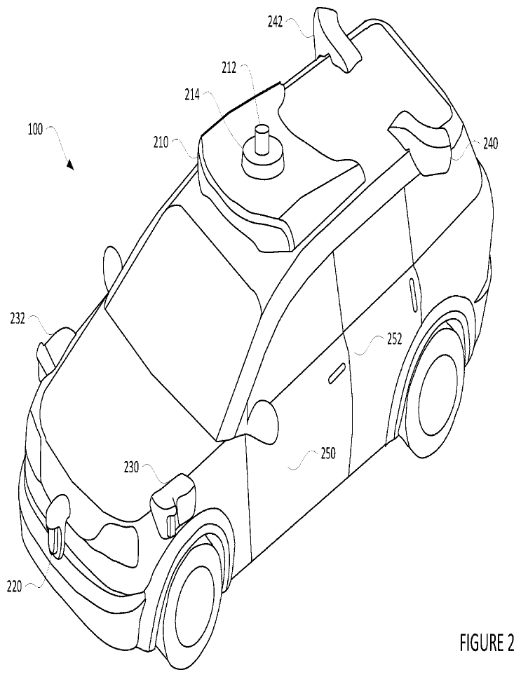

For instance, FIG. 2 is an example external view of vehicle 100. In this example, roof-top housings 210, 212, 214 may include a LIDAR sensor as well as various cameras and radar units. In addition, housing 220 located at the front end of vehicle 100 and housings 230, 232 on the driver's and passenger's sides of the vehicle may each store a LIDAR sensor. For example, housing 230 is located in front of doors 250, 252. Vehicle 100 also includes housings 240, 242 for radar units and/or cameras also located on the roof of vehicle 100. Additional radar units and cameras (not shown) may be located at the front and rear ends of vehicle 100 and/or on other positions along the roof or roof-top housing 210.

The computing devices 110 may be capable of communicating with various components of the vehicle in order to control the movement of vehicle 100 according to primary vehicle control code of memory of the computing devices 110. For example, returning to FIG. 1, the computing devices 110 may include various computing devices in communication with various systems of vehicle 100, such as deceleration system 160, acceleration system 162, steering system 164, routing system 166, planning system 168, positioning system 170, perception system 172, and power system 174 (i.e. the vehicle's engine or motor) in order to control the movement, speed, etc. of vehicle 100 in accordance with the instructions 132 of memory 130.

The various systems of the vehicle may function using autonomous vehicle control software in order to determine how to and to control the vehicle. As an example, a perception system software module of the perception system 172 may use sensor data generated by one or more sensors of an autonomous vehicle, such as cameras, LIDAR sensors, radar units, sonar units, etc., to detect and identify objects and their features. These features may include location, type, heading, orientation, speed, acceleration, change in acceleration, size, shape, etc. In some instances, features may be input into a behavior prediction system software module which uses various behavior models based on object type to output a predicted future behavior for a detected object.

In other instances, the features may be put into one or more detection system software modules, such as a traffic light detection system software module configured to detect the states of known traffic signals, a school bus detection system software module configured to detect school busses, construction zone detection system software module configured to detect construction zones, a detection system software module configured to detect one or more persons (e.g. pedestrians) directing traffic, a traffic accident detection system software module configured to detect a traffic accident, an emergency vehicle detection system configured to detect emergency vehicles, etc. Each of these detection system software modules may input sensor data generated by the perception system 172 and/or one or more sensors (and in some instances, map information for an area around the vehicle) into various models which may output a likelihood of a certain traffic light state, a likelihood of an object being a school bus, an area of a construction zone, a likelihood of an object being a person directing traffic, an area of a traffic accident, a likelihood of an object being an emergency vehicle, etc., respectively.

Detected objects, predicted future behaviors, various likelihoods from detection system software modules, the map information identifying the vehicle's environment, position information from the positioning system 170 identifying the location and orientation of the vehicle, a destination for the vehicle as well as feedback from various other systems of the vehicle may be input into a planning system software module of the planning system 168. The planning system may use this input to generate trajectories for the vehicle to follow for some brief period of time into the future based on a current route of the vehicle generated by a routing module of the routing system 166. A control system software module of the computing devices 110 may be configured to control movement of the vehicle, for instance by controlling braking, acceleration and steering of the vehicle, in order to follow a trajectory.

Computing devices 110 may also include one or more wireless network connections 150 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

The computing devices 110 may control the vehicle in an autonomous driving mode by controlling various components. For instance, by way of example, the computing devices 110 may navigate the vehicle to a destination location completely autonomously using data from the detailed map information and planning system 168. The computing devices 110 may use the positioning system 170 to determine the vehicle's location and perception system 172 to detect and respond to objects when needed to reach the location safely. Again, in order to do so, computing device 110 may generate trajectories and cause the vehicle to follow these trajectories, for instance, by causing the vehicle to accelerate (e.g., by supplying fuel or other energy to the engine or power system 174 by acceleration system 162), decelerate (e.g., by decreasing the fuel supplied to the engine or power system 174, changing gears, and/or by applying brakes by deceleration system 160), change direction (e.g., by turning the front or rear wheels of vehicle 100 by steering system 164), and signal such changes (e.g. by using turn signals). Thus, the acceleration system 162 and deceleration system 160 may be a part of a drivetrain that includes various components between an engine of the vehicle and the wheels of the vehicle. Again, by controlling these systems, computing devices 110 may also control the drivetrain of the vehicle in order to maneuver the vehicle autonomously.

### Example Sensor

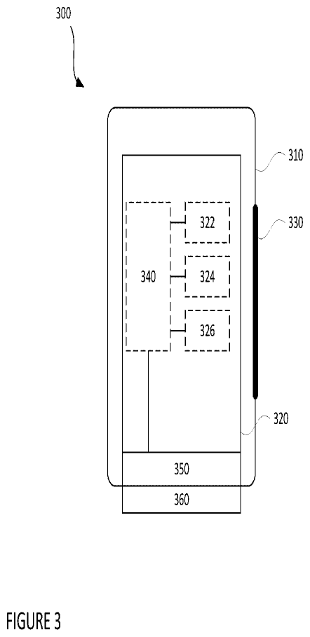

FIG. 3 provides a functional diagram of an example LIDAR sensor 300 which may correspond to any of the sensors of housings 212, 220, 230, 232. The sensor 300 may be incorporated into the aforementioned perception system and/or may be configured to receive commands from the computing devices 110, for instance via a wired or wireless connection. The sensor 300 may include a housing 310 to protect the internal sensor components 320, (shown in dashed-line in FIG. 3 as they are internal to the housing 310) from debris such as water, dirt, insects, and other contaminants. However, over time, the housing and other sensor components may collect debris. As such, the functions of internal sensor components 320 may be impeded as signals transmitted and received by the internal sensor components may be blocked by the debris. To address this, debris may be cleared from the sensor 300 by using a cleaning fluid.

The housing 310 may be configured in various shapes and sizes. As noted above, the housing may be configured as any of the housings 212, 230, 232. The housing may be comprised of materials such as plastic, glass, polycarbonate, polystyrene, acrylic, polyester, etc. For instance, the housing may be a metal or plastic housing and the internal sensor components 320 have a “window”, aperture, or sensor input surface 330 that allows the sensor to transmit and/or receive signals.

The internal sensor components 320 may transmit and receive one or more signals through the sensor input surface 330. The sensor input surface 330 may be a lens, mirror or other surface by which the signals can pass or are directed to other sensor components in order to generate sensor data. The internal sensor components may include one or more laser light sources 322, one or more receivers 324 (such as photodetectors), various beam-steering components 326 (such as lenses and mirrors to direct a pulse or stream of light out of the sensor and to direct returning light to the one or more receivers 324), and a controller 340. The laser light sources 322 may include those that generate discrete pulses of light or a continuous stream of light. The controller 340 may include one or more processors, such as the one or more processors 120 or other similarly configured processors.

For time of flight (ToF) LIDAR sensors, the direction of a pulse of light generated by a laser light source, light received at the receivers, and time of flight may be used by the controller 340 of the sensor 300 and/or another system of the vehicle (e.g. the perception system) to determine the location of the surface, and the amplitude of the returning light may be used to determine the reflectivity of the surface. Together, this additional sensor data may be considered a LIDAR sensor data point. In some lidars, frequency may be used to define the sensor data point e.g., in frequency modulated continuous wave (FMCW) LIDAR sensors having a corresponding range of wavelengths. Each of these LIDAR sensors may emit light in many different directions. Point clouds or groups of LIDAR sensor data points can be generated by LIDAR sensors and/or other systems of the vehicle 100. The sensor data may be used by the various systems of the vehicle 100 in order to control the vehicle in the autonomous driving mode as described above. In this regard, the controller 340 may publish sensor data, that is, make the sensor data available to the various other systems of the vehicle 100.

One or both of the housing 310 and the internal sensor components 320 may be rotatable, though in other examples, neither the housing nor the internal sensor components may be rotatable. To enable the rotation, the internal sensor components 320 and/or the housing 310 may be attached to a motor 350. In one example, the internal sensor components may be fixed to the vehicle with a bearing assembly that allows rotation of the internal sensor components 320 and housing 310 but keeps other components of the sensor fixed. As an alternative, the internal sensor components and the housing may be configured to rotate independently of one another. In this regard, all or a portion of the housing 310 may be transparent in order to enable signals to pass through the housing and to reach the internal sensor components 320. In addition, to enable independent rotation, a first motor may be configured to rotate the housing 310 and a second motor may be configured to rotate the internal sensor components. In this example, the housing may be rotated to enable cleaning while the internal sensor components may still function to capture signals and generate sensor data.

An encoder 360 may be used to track the position of the motor 350, housing 310, and/or the internal sensor components 320. In this regard, the controller may control the motor 350 in order to rotate the housing 310 and/or the internal sensor components 320 based on feedback from the encoder 360. As noted below, this rotation can be used to attempt to clear cleaning fluid, water, and/or other debris from the sensor input surface 330.

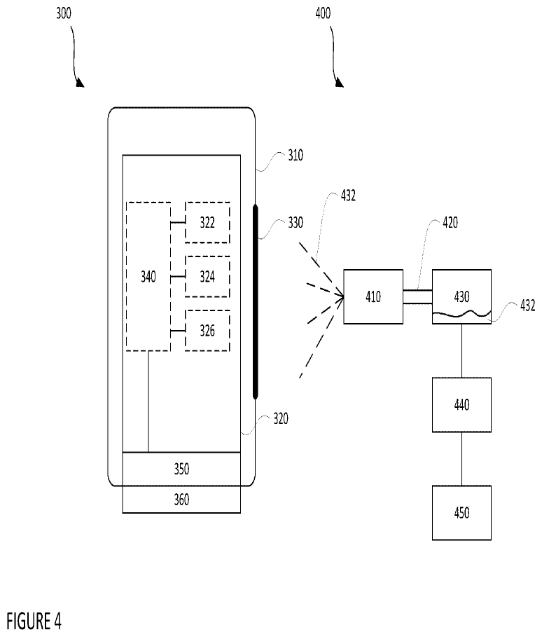

FIG. 4 is an example functional diagram of a cleaning system 400 and the sensor 300. In this example, one or more nozzles 410 may be connected, for instance via tubing 420, to a fluid reservoir 430 storing cleaning fluid 432, as well as a pump 440 in order to force cleaning fluid out of the nozzle as needed to assist in the cleaning of the sensor input surface 330. The one or more nozzles 410 may be positioned with respect to the housing 310 in order to spray the cleaning fluid 432 at the sensor input surface 330. A controller 450 may include one or more processors and memory, configured the same or similarly to processors 120 and memory 130. The controller 450 may be configured to receive a signal, for instance from the computing devices 110, indicating that the sensor input surface 330 requires cleaning and may respond by activating the pump and/or other features of the cleaning system in order to force the cleaning fluid 432 to spray through the nozzle 410 (as represented by dashed-lines 434 of FIG. 4) and onto the sensor input surface.

The cleaning fluid 432 used to clean the sensor input surface 330 may be selected to be opaque for the wavelength or range of wavelengths of the light generated by the sensor 300 or rather, the operating wavelength or range of wavelengths. For example, if the sensor 300 utilizes 905 nm or 1550 nm pulses of light, the cleaning fluid may be opaque to that wavelength of light or to at least a range of wavelengths of light including 905 nm or 1550 nm.

Different types of liquids and pigments may be added to typical cleaning fluids in order to make the cleaning fluid opaque for the wavelength or range of wavelengths of the light generated by the LIDAR sensor. As one example, these liquids may include those that are opaque in the visible spectrum of light (e.g. 400 nm to 700 nm) such as black or even super black food coloring which may also be opaque to a LIDAR sensor's operating wavelength or range of wavelengths. As another example, these liquids may include those that are only opaque in a LIDAR sensor's operating wavelength or range of wavelengths, and otherwise transparent in the visible wavelengths. Such liquids may include “invisible inks” and other non-toxic fluids. In addition, because water is still largely transparent in the near infrared spectrum, pigments dissolved in water can be very effective for a LIDAR sensor's operating wavelength or range of wavelengths.

In addition or alternatively, small, concentrated pigments can be embedded in small areas of the outer aperture. When the aperture contains water droplets, these pigments can slowly dissolve into those water droplets to make them opaque.

### Example Methods

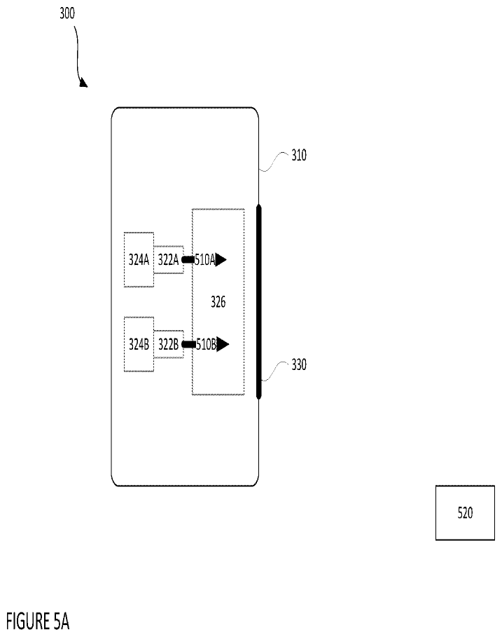

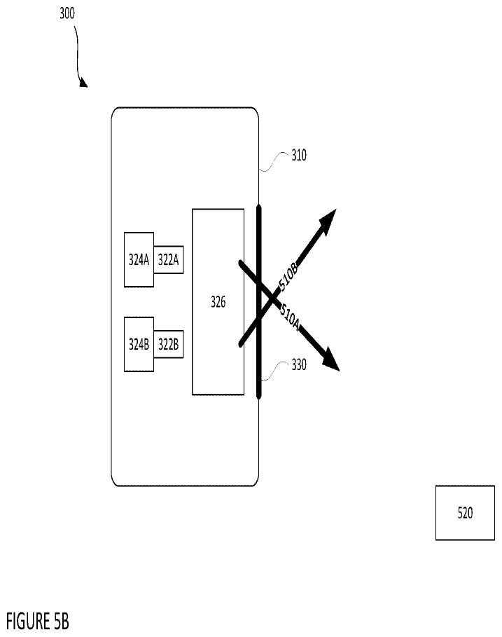

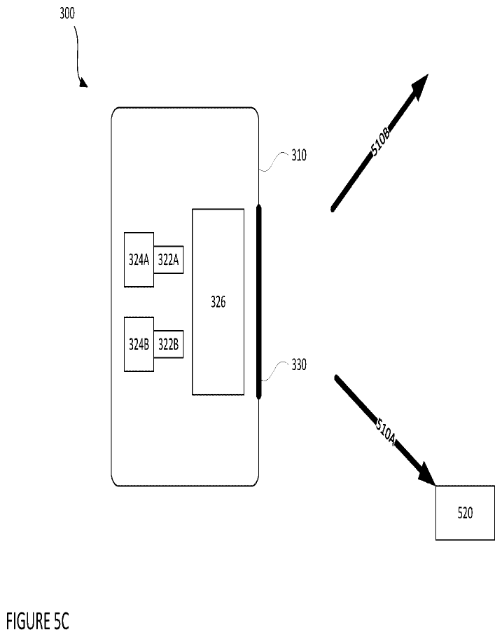

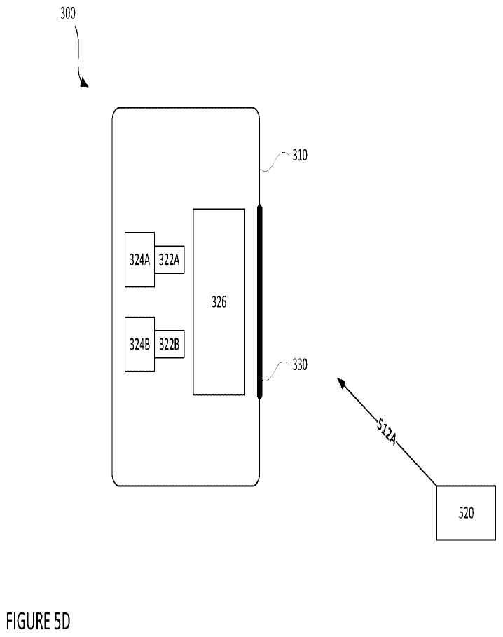

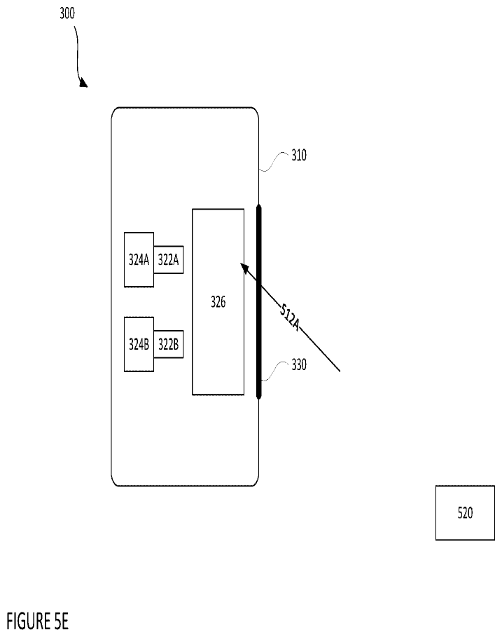

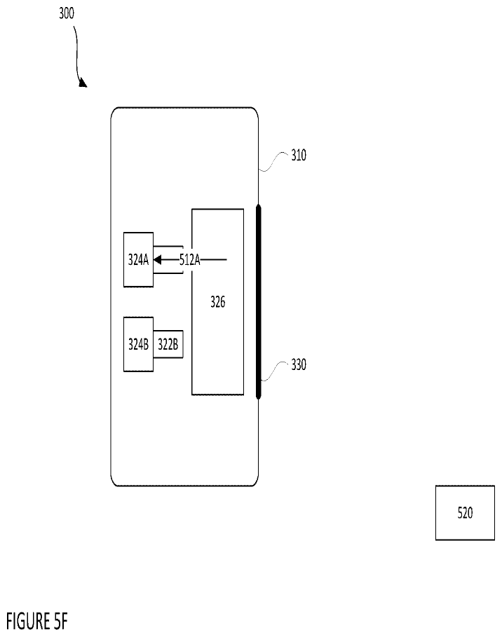

During operation, the sensor 300 may function by using the laser light source 322 to generate a light at a certain wavelength or range of wavelengths in a certain direction. For example, FIGS. 5A-5F provide an example representation of aspects of the sensor 300 when in operation. Turning to FIG. 5A, each of laser light sources 322A, 322B generate a pulse of light 510A, 510B. The beam-steering components 326 may direct the light through the sensor input surface 330 in different directions as shown in FIG. 5B. The light may be reflected off of a surface of an object and returned back to the sensor. The pulses of light may contact one or more objects in the environment of the sensor 300 (or rather, the vehicle 100). For example, turning to FIG. 5C, the pulse of light 510A may contact an object 520, and all or a portion of that pulse of light, now reflected light 512A, may be reflected back towards the sensor 300 as shown in FIG. 5D. The reflected light 512A may pass through the sensor input surface 330 as shown in FIG. 5E, and be directed by the beam-steering components 326 back to the receiver 324A as shown in FIG. 5F. The receivers 324 (including receivers 324A and 324B) may generate sensor data such as the direction of the received light and time of flight. As noted above, this sensor data may be used by various systems of the vehicle 100 to make driving decisions when the vehicle is operating in an autonomous driving mode or rather to control the vehicle in an autonomous driving mode.

In some instances, the controller 450 may receive a signal, for example, from computing devices 110, indicating that the sensor input surface 330 requires cleaning. This information may be generated by another system, such as the computing devices 110 or another system, configured to determine whether the sensor window is dirty. For example, this system may capture images of the sensor window and processes these images to determine whether there is any foreign object debris located on the sensor window.

As noted above, the controller 450 may respond by activating the pump 440 and/or other features of the cleaning system 400 in order pump the cleaning fluid 432 from the reservoir through the tubing 420 until it reaches the nozzle 410. The nozzle 410 may direct a spray of the cleaning fluid 432 towards the sensor input surface 330 of the sensor 300.

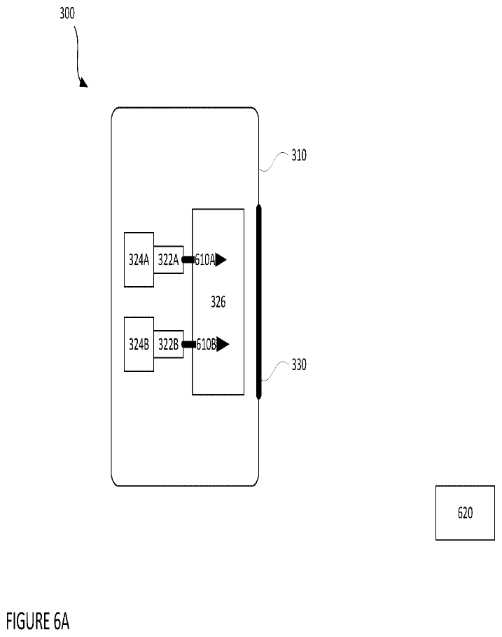

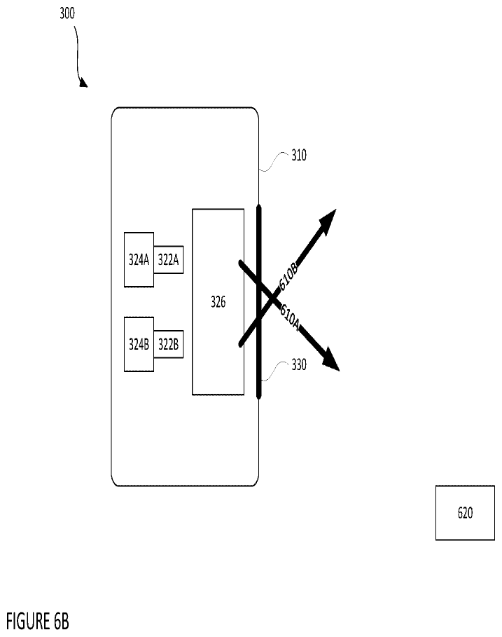

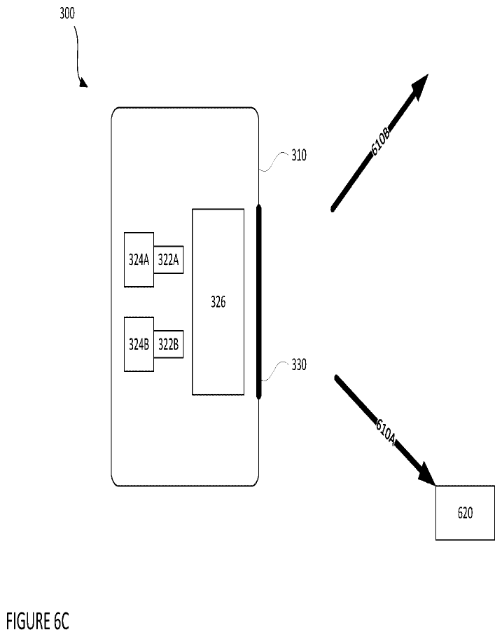

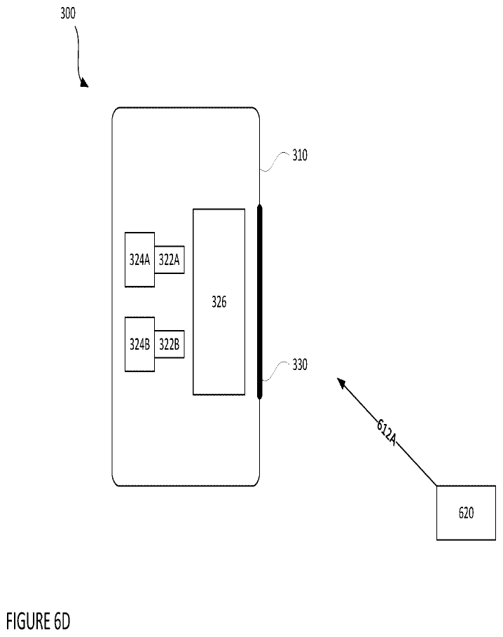

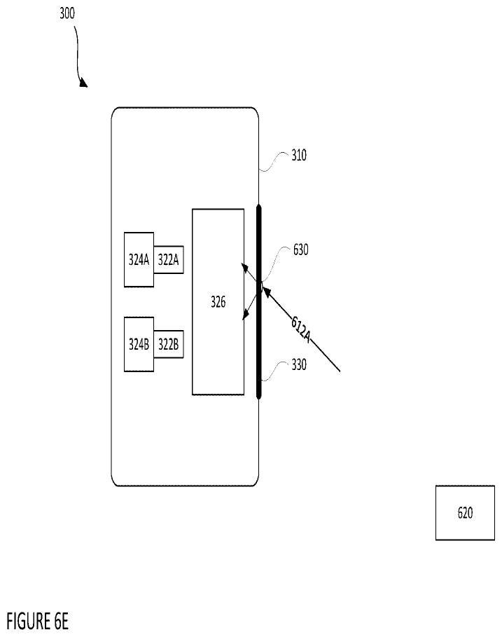

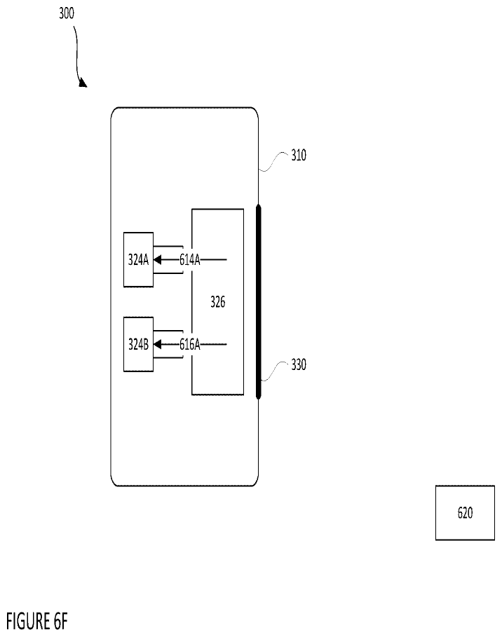

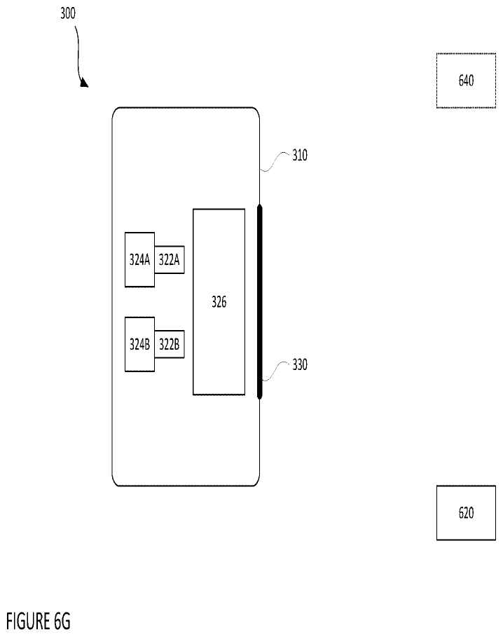

As noted above, water droplets and other foreign object debris can change the characteristics of the return light. For example, they may cause returning light to be directed towards the wrong internal receiver. For example, FIGS. 6A-6F provide an example representation of aspects of the sensor 300 and demonstrate how water droplets, typical cleaning fluids (i.e. not the cleaning fluid 432), or other foreign debris can cause returning light to be directed towards the wrong internal receiver. Turning to FIG. 6A, each of laser light sources 322A, 322B generate a pulse of light 610A, 610B. The beam-steering components 326 may direct the light through the sensor input surface 330 in different directions as shown in FIG. 6B. The light may be reflected off of a surface of an object and returned back to the sensor. The pulses of light may contact one or more objects in the environment of the sensor 300 (or rather, the vehicle 100). For example, turning to FIG. 6C, the pulse of light 610A may contact an object 620, and all or a portion of that pulse of light, now reflected light 612A, may be reflected back towards the sensor 300 as shown in FIG. 6D. In this example, the reflected light 612A may pass through a drop 630 of typical cleaning fluid, water or other debris on the sensor input surface 330 before passing through the sensor input surface as shown in FIG. 6E. This drop 630 may allow a portion 614A of the reflected light 612A to pass through the beam-steering components 326 and be back to the receiver 324A as shown in FIG. 6F. However, the drop 630 may also deflect a portion 616A of the reflected light 612A to the receiver 324B. The receivers 324 (including receivers 324A and 324B) may generate sensor data such as the direction of the received light and time of flight.

The portion 616A of the reflected light 612A that reaches receiver 624B may result in crosstalk artifacts, such as false object 640 of FIG. 6G shown in dashed-line, that do not actually exist in the scene. In other words, the sensor 300 may publish sensor data for an object that does not actually exist. This phenomenon can be amplified in LIDAR sensors which include one or more laser light sources that generate light in many different directions. Such artifacts are often found around objects that reflect a large amount of light back towards the LIDAR sensor, such as retroreflectors or specular reflectors at normal incidence, amplifying the impact of stray light paths to incorrect receivers of the LIDAR sensor.

In some instances, real objects can often be within these crosstalk artifacts seen in a point cloud. In addition, crosstalk artifacts can cause other signals to be lost as the LIDAR sensor may be saturated by the artifact signal before it receives light from actual objects in the scene further away.

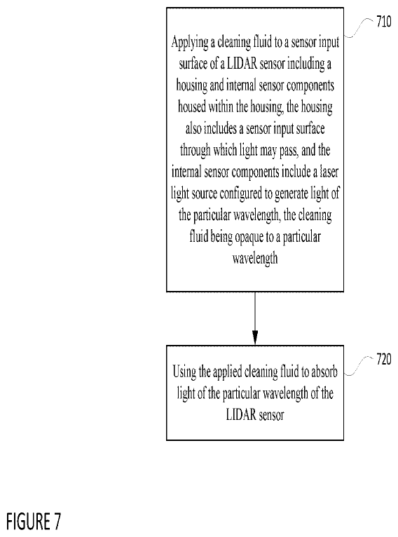

FIG. 7 provides an example method for cleaning a LIDAR sensor. When cleaning the sensor input surface of a sensor, such as the sensor input surface 330 of the sensor 300, rather than using a typical cleaning fluid, at block 710, a cleaning fluid that is opaque to the particular wavelength is applied to a sensor input surface of a LIDAR sensor including a housing and internal sensor components housed within the housing. The housing also includes a sensor input surface through which light may pass. The internal sensor components include a laser light source configured to generate light of the particular wavelength.

As such, at block 720, the applied cleaning fluid is used to absorb light of the particular wavelength. This cleaning fluid may include the cleaning fluid 432. In this regard, the applied cleaning fluid may be in the visible spectrum of light or transparent in the visible spectrum of light. As noted above, such cleaning fluids may include food coloring, liquids may include those that are only opaque in the sensor 300's operating wavelength or range of wavelengths and otherwise transparent in the visible wavelengths, or pigments dissolved in water which are opaque in the sensor 300's operating wavelength or range of wavelengths. In addition, in some cases, the applied cleaning fluid may mix with the foreign object debris on the sensor input surface.

Once the cleaning fluid is spray or otherwise applied to the aperture, any water droplets remaining on the aperture may also be opaque to the wavelengths of the light generated by the LIDAR sensor. In other words, the applied cleaning fluid may be used to reduce a likelihood of light of particular wavelength passing through the cleaning fluid resulting in a crosstalk artifact being generated by the LIDAR sensor. This reduces a likelihood of a reflected portion of the light being received at another of the plurality of receivers.

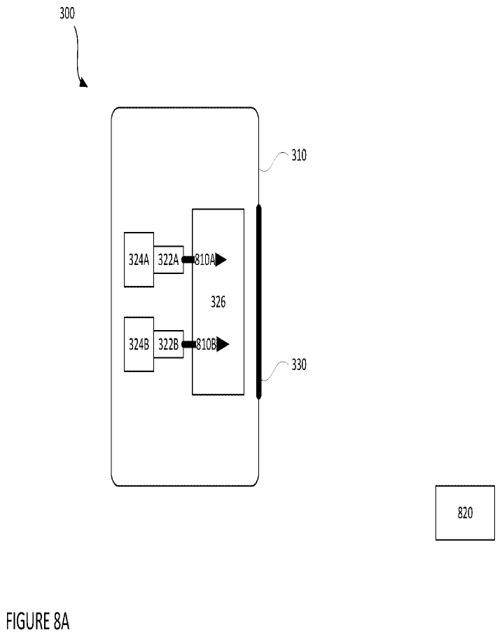

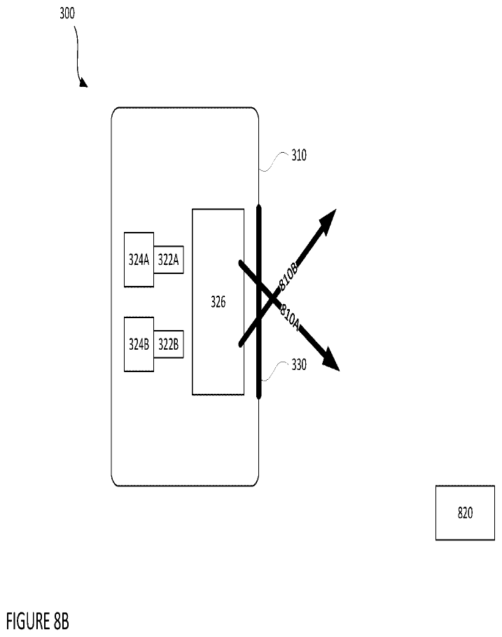

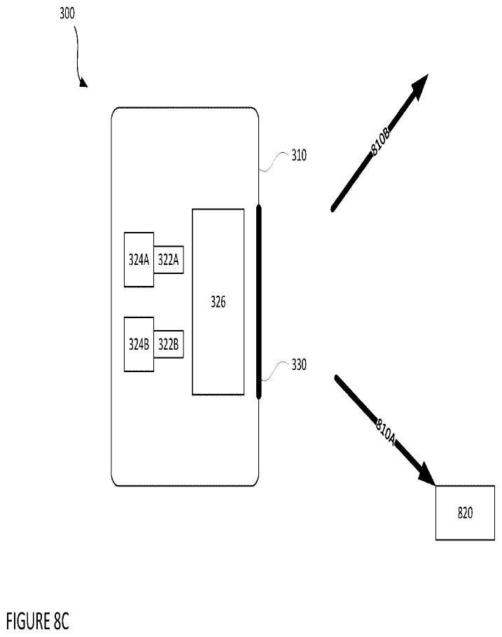

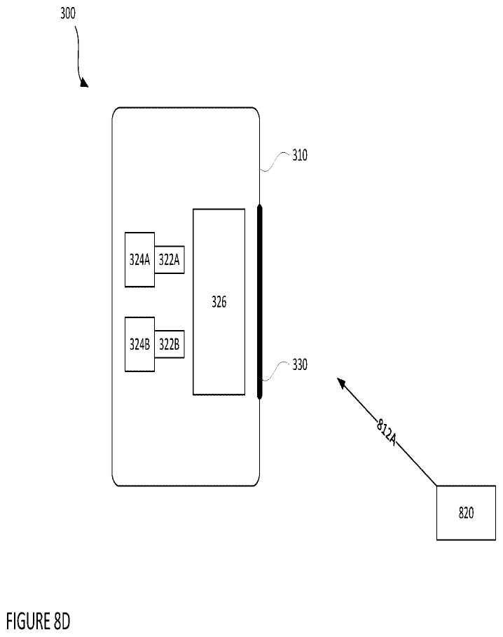

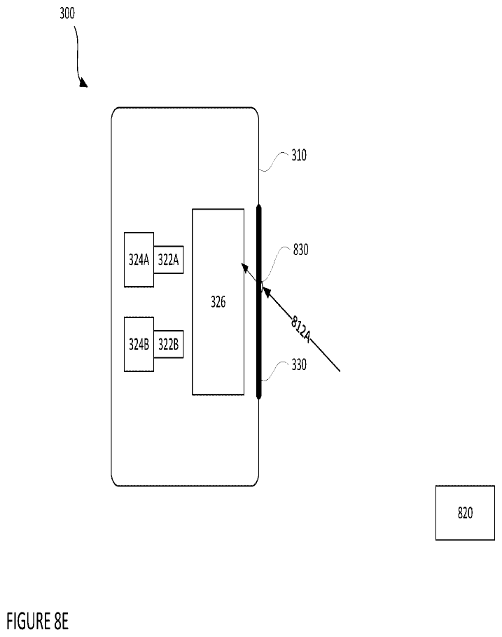

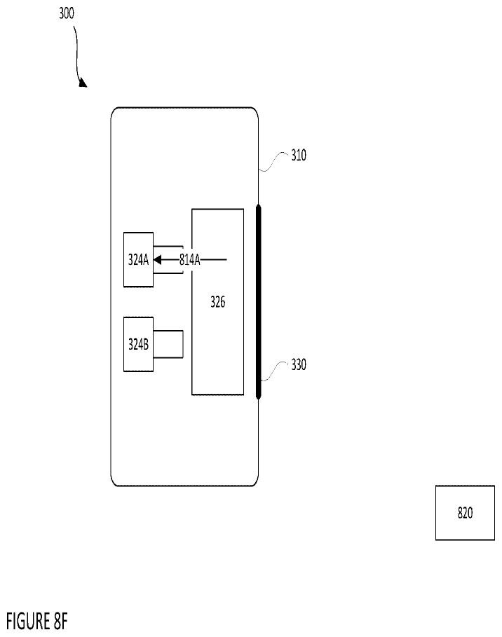

For example, FIGS. 8A-6F provide an example representation of aspects of the sensor 300 and demonstrate how water the cleaning fluid 432 may reduce the likelihood of the sensor generating crosstalk artifacts. Turning to FIG. 8A, each of laser light sources 322A, 322B generate a pulse of light 810A, 810B. The beam-steering components 326 may direct the light through the sensor input surface 330 in different directions as shown in FIG. 8B. The light may be reflected off of a surface of an object and returned back to the sensor. The pulses of light may contact one or more objects in the environment of the sensor 300 (or rather, the vehicle 100). For example, turning to FIG. 8C, the pulse of light 810A may contact an object 820, and all or a portion of that pulse of light, now reflected light 812A, may be reflected back towards the sensor 300 as shown in FIG. 8D. In this example, the reflected light 812A may pass through a drop 830 of the cleaning fluid 432 on the sensor input surface 330 before passing through the sensor input surface as shown in FIG. 8E. This drop 830 may allow a portion 814A of the reflected light 812A to pass through the beam-steering components 326 and be back to the receiver 324A as shown in FIG. 8F. However, the drop 830 may also deflect a portion 816A of the reflected light 812A to the receiver 324B. The receivers 324 (including receivers 324A and 324B) may generate sensor data such as the direction of the received light and time of flight.

Although the examples of FIGS. 5A-5F, 6A-6G, and 8A-8F relate to pulses of light such as those generated by ToF LIDAR sensors, similar results may be expected with continuous streams of light at a range of wavelengths such as those generated by FMCW LIDAR sensors. In such cases, the cleaning fluid utilized may be selected to be opaque to this range of wavelengths. In addition, rotation (as described above) or other movement of the housing, puffs of air or other gasses from a nozzle, and/or one or more wipers may then be used to clear the aperture of the cleaning fluid 432. Any remaining pigment left on the aperture after the cleaning fluid or water evaporates can be removed at a later time, perhaps when it is more convenient to perform maintenance on the lidar apertures. For example, such cleaning may occur at a garage or depot during a maintenance period for the vehicle.

In addition, any water droplets remaining as a result of the cleaning may also be opaque to the LIDAR sensor's operating wavelength or range of wavelengths. As such any light having the wavelength or range of wavelengths, hitting the cleaning fluid (or droplets mixed with the cleaning fluid), and that would have otherwise scattered in the wrong direction and be set to the wrong receivers, may be absorbed by the cleaning fluid. This may reduce the likelihood of crosstalk artifacts and thereby improve crosstalk performance of a LIDAR sensor. While there may be some impact on the range performance of the LIDAR sensor due to the any remnants of the cleaning fluid being left on the aperture after cleaning which may block some returning light from reaching the receivers, this may be balanced with the improvements with regard to crosstalk artifacts.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system for cleaning a LIDAR sensor, the system comprising:
the LIDAR sensor including a housing and internal sensor components housed within the housing, the housing including a sensor input surface through which light may pass and wherein the internal sensor components are configured to generate a light of a particular wavelength; and
a cleaning fluid that is opaque to the particular wavelength, such that when the cleaning fluid is applied to the sensor input surface, the cleaning fluid absorbs light of the particular wavelength.

2. The system of claim 1, wherein the cleaning fluid is configured to reduce a likelihood of light of particular wavelength passing through the cleaning fluid resulting in a crosstalk artifact.

3. The system of claim 1, wherein the internal sensor components further include a plurality of receivers, and wherein reflected light the cleaning fluid reduces a likelihood of a reflected portion of the light being received at another of the plurality of receivers.

4. The system of claim 1, wherein the cleaning fluid is opaque in the visible spectrum of light.

5. The system of claim 4, wherein the cleaning fluid includes food coloring.

6. The system of claim 1, wherein the cleaning fluid is transparent in the visible spectrum of light.

7. The system of claim 1, wherein the cleaning fluid includes a pigment that is opaque to the particular wavelength.

8. The system of claim 1, further comprising a vehicle, and wherein the LIDAR sensor is attached to the vehicle.

9. The system of claim 8, wherein the vehicle is configured to use sensor data generated by the LDAR sensor to make driving decisions for the vehicle when the vehicle is operating in an autonomous driving mode.

10. The system of claim 1, wherein the cleaning fluid is configured to mix with foreign object debris on the sensor input surface.

11. A method for cleaning a LIDAR sensor including a housing and internal sensor components housed within the housing, the housing including a sensor input surface through which light may pass and wherein the internal sensor components are configured to generate light of a particular wavelength, the method comprising:
applying a cleaning fluid to the sensor input surface, wherein the cleaning fluid is opaque to the particular wavelength; and
using the applied cleaning fluid to absorb light of the particular wavelength.

12. The method of claim 11, further comprising using the applied cleaning fluid to reduce a likelihood of light of particular wavelength passing through the cleaning fluid resulting in a crosstalk artifact.

13. The method of claim 11, wherein the internal sensor components further include a plurality of receivers, and the method further comprising, using the applied cleaning fluid to reduce a likelihood of a reflected portion of the light being received at another of the plurality of receivers.

14. The method of claim 11, wherein the applied cleaning fluid is opaque in the visible spectrum of light.

15. The method of claim 14, wherein the applied cleaning fluid includes food coloring.

16. The method of claim 11, wherein the applied cleaning fluid is transparent in the visible spectrum of light.

17. The method of claim 11, wherein the applied cleaning fluid includes a pigment that is opaque to the particular wavelength.

18. The method of claim 11, further comprising using data generated by the LIDAR sensor to make driving decisions for a vehicle when the vehicle is operating in an autonomous driving mode.

19. The method of claim 11, further comprising mixing the applied cleaning fluid with foreign object debris on the sensor input surface.

20. A vehicle comprising:
a LIDAR sensor including a housing and internal sensor components housed within the housing, the housing including a sensor input surface through which light may pass and wherein the internal sensor components are configured to generate a light of a particular wavelength;
one or more processors configured to control the vehicle in an autonomous driving mode based on sensor data generated by the LIDAR sensor; and
a cleaning fluid that is opaque to the particular wavelength, such that when the cleaning fluid is applied to the sensor input surface, the cleaning fluid absorbs light of the particular wavelength.
